(19) United States
(12) Patent Application Publication
(10) Pub. No.: US 2010/0033337 A1
(43) Pub. Date: Feb. 11, 2010

(54) MEDICAL DEVICE AND MEDICAL SYSTEM INCLUDING MEDICAL DEVICE

(76) Inventor: Akira SUZUKI, Uenohara-shi (JP)

Correspondence Address: OSTROLENK FABER GERB & SOFFEN, 1180 AVENUE OF THE AMERICAS, NEW YORK, NY, 100368403, US

(21) Appl. No.: 12/582,776

(22) Filed: Oct. 21, 2009

Related U.S. Application Data
(63) Continuation of application No. PCT/JP2007/062714, filed on Jun. 25, 2007.

(51) Int. Cl. G08B 21/02; G08B 21/00

(52) U.S. Cl. 340/679; 340/687

(57) ABSTRACT

A medical device includes a first notification mechanism capable of notifying a user of information indicating that the medical device is suitable for use with a patient having a specified disease.

### CROSS REFERENCE TO RELATED APPLICATIONS

This is a Continuation Application of PCT Application No. PCT/JP2007/062714, filed Jun. 25, 2007, which was published under PCT Article 21(2) in Japanese.

### BACKGROUND OF THE INVENTION

1. Field of the Invention

The present invention relates to a medical device which notifies users of information indicating that the medical device is suitable for use for a patient having a specified disease such as an infectious disease, and to a medical system including the medical instrument.

2. Description of the Related Art

Presently, various kinds of medical devices are used in the field of medicine. Such medical devices are given identification codes provided at arbitrary positions, and are efficiently managed by the identification codes. Such medical devices are disclosed, for example, in Patent Documents 1 and 2.

For example, in Patent Document 1, small steel items such as surgical knives, scissors, and forceps used for diagnosis are respectively provided with identification codes which are readable by a reading device. The reading device is connected to a management device which manages information read by the reading device. The management device is provided with an input device for inputting medical data in advance, such as data concerning a patient and a doctor attending the patient, and is also provided with a database for storing the medical data input by the input device. After performing a surgical operation, etc. on a patient, medical management is carried out by comparing the medical data with read data.

Further, according to Patent Document 2, a barcode (a record part) where an ID number is recorded is provided on a surface of a surgical instrument such as a pair of forceps. Such barcodes are read by a reading device. The reading device is connected to a personal computer which is further connected to a database. The database is input with and accumulates types of surgical instruments and information about suitable usage for the types, from the personal computer.

The reading device reads a barcode and the ID number is inputs to the personal computer. The personal computer extracts information from the database. In this manner, a type of a surgical instrument is determined. Information concerning the surgical instruments is displayed on a screen of the personal computer. Furthermore, an ID number is input to the personal computer by reading a barcode by a reading device, and relevant new information can then be additionally input to the database.

Patent Document 1: Jpn. Pat. Appln. KOKAI Publication No. 2003-016198

Patent Document 2: Jpn. Pat. Appln. KOKAI Publication No. 07-178107

### BRIEF SUMMARY OF THE INVENTION

Accordingly, the present invention provides a medical device including a notification mechanism which easily notifies a user of information indicating that a device is suitable for use for a patient, and a medical system including the medical device.

According to an aspect of the invention, there is provided a medical device comprising a first notification mechanism capable of notifying a user of information indicating that the medical device suitable for use with a patient having a specified disease.

According to another aspect of the invention, there is provided a medical system comprising a medical device including a first notification mechanism capable of notifying a user of information indicating that the medical device is suitable for use with a patient having a specified disease, an input mechanism capable of inputting patient information associated with disease information concerning the disease, the patient information concerning the patient on whom a medical practice is performed, a second notification mechanism capable of notifying the patient information or the disease information when the medical practice is performed on the patient and a body section connected detachably to the medical device and including the input mechanism and the second notification mechanism.

The invention thus provides a medical device including a notification mechanism which easily notifies a user of information indicating that a device is suitable for use for a patient, and a medical system including the medical device.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWINGS

FIG. 1 is a view illustrating a schematic structure of a medical device according to the first embodiment;

FIG. 2 is a view illustrating an example of a first notification mechanism which announces device information by text;

FIG. 3 is a view illustrating a schematic structure of a medical system according to the second embodiment;

FIG. 4 is a view illustrating an example of the second notification mechanism which announces patient information or disease information; and

FIG. 5 is a view illustrating an example of the second notification mechanism which announces medical schedule information.

### DETAILED DESCRIPTION OF THE INVENTION

Hereinafter, embodiments of the present invention will be described with reference to the drawings.

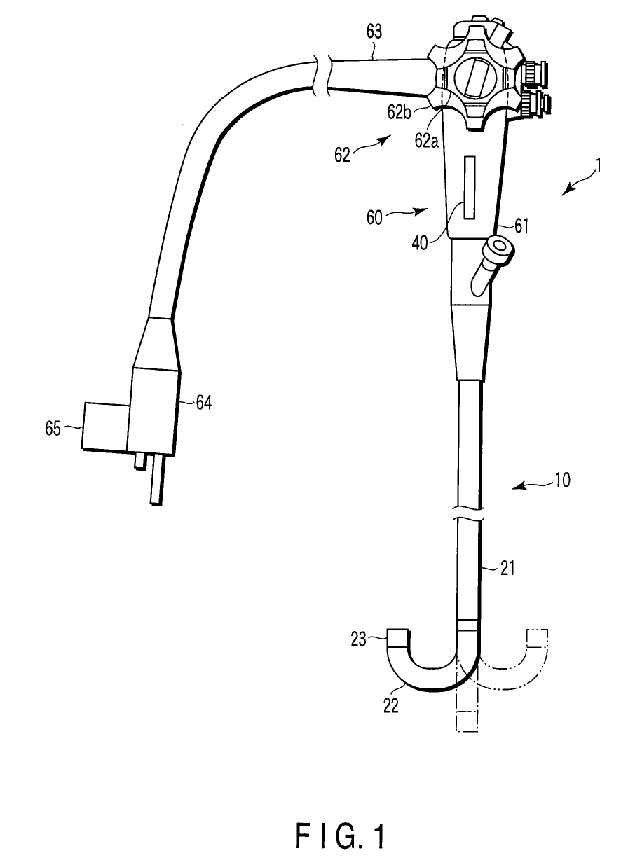

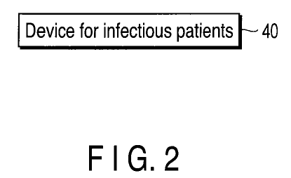

The first embodiment will now be described with reference to FIGS. 1 to 2.

As illustrated in FIG. 1, an endoscope 1 as a medical device is provided with a narrow insertion section 10 which is inserted into a body cavity of a patient and a manipulation section 60 that is connected to a base end positioned in a bottom side of the insertion section 10, to manipulate the insertion section 10. The insertion section 10 is a functional section of the endoscope 1 which is directly used for a patient.

The manipulation section 60 is provided with a grip section 61 which a user such as a surgical operator grasps, and a bend manipulation knob set 62 for bending a bending section 22, described later, of the insertion section 10.

The grip section 61 is connected to a base end section of a universal cord 63. Connected to a top end of the universal cord 63 are a light source device 80 in the second embodiment described later and a connector section 64 connected to a video processor 70.

The bend manipulation knob set 62 includes a horizontal bend manipulation knob 62a by which the bending section 22 is manipulated to bend horizontally; and a vertical bend manipulation knob 62b by which the bending section 22 is manipulated to bend vertically. The horizontal bend manipulation knob 62a is connected to a bend manipulation mechanism for horizontal directions, which is driven by the horizontal bend manipulation knob 62a. The vertical bend manipulation knob 62b is connected to a bend manipulation mechanism for vertical directions, which is driven by the vertical bend manipulation knob 62b. The bend manipulation mechanisms for bending in horizontal and vertical directions are provided on the manipulation section 60.

The insertion section 10 includes a flexible tube section (flexible hose section) 21, the bending section 22, and a distal end top section 23 arranged in this order from the manipulation section 60. Specifically, the manipulation section 60 is connected to a base end of the narrow flexible tube section (flexible hose section) 21. A distal end of the flexible tube section 21 is connected to a proximal end of the bending section 22. A distal end of the bending section 22 is connected to a proximal end of the distal end top section 23.

The flexible tube section 21 is, for example, made of resin and has a hollow shape.

The bending section 22 can be manipulated to bend from a normal linear state of extending straight, as denoted by a one-dot chain line in FIG. 1 to a state denoted by a continuous line or a two-dot chain line in the figure.

For example, the grip section 61 of the endoscope 1 is provided with a first notification (display) mechanism 40. The first notification mechanism 40 directly notifies a user of device information indicating that the endoscope 1 is a device suitable for use with an infectious patient. An infectious patient is, for example, a patient who contracts a specified disease such as an infectious disease. Device information is information which is set in advance.

The first notification mechanism 40 announces (notifies) device information as a text, for example, as illustrated in FIG. 2. Alternatively, the first notification mechanism 40 may give a notification by combining a color with the text illustrated in FIG. 2. Thus, the first notification mechanism 40 may announce device information by using at least one of a text, a color, a sound, and an index. Since the first notification mechanism 40 switches the text, color, sound, and index, depending on device information to be notified of, users are enabled to identify for which patient the endoscope 1, which includes the first notification mechanism 40 as a device, is suitable for use with.

Alternatively, the first notification mechanism 40 may announce device information by lighting or blinking (flashing) when the endoscope 1 is connected to the light source device 80 or a video processor 70. Further alternatively, the first notification mechanism 40 may give a notification added with device information when the endoscope 1 is used.

The first notification mechanism 40 need not always be provided on the grip section 61 and need only be provided somewhere on the endoscope 1. Therefore, the first notification mechanism 40 may be provided at the insertion section 10. In a case that the first notification mechanism 40 announces device information by a color, for example, the entire endoscope 1 may be colored in a certain color and the endoscope 1 itself then functions as the first notification mechanism 40. Of course, the part to be colored is not limited to the entire endoscope 1, and the same effect is achieved insofar as at least one of the insertion section 10 and the grip section 61 is colored.

A description will now be made of an operation method for the medical device according to the present embodiment.

When the endoscope 1 is used by a user, the first notification mechanism 40 announces that the endoscope 1 is a device suitable for use for infectious patients, by a text as illustrated in FIG. 2. In this manner, the first notification mechanism 40 directly notifies the user of information from the endoscope 1, and lets the user directly identify that the endoscope 1 is applicable to such infectious patients. Accordingly, the first notification mechanism 40 lets the user identify, for example, that the endoscope 1 is for infectious patients other than ordinary patients.

Thus, when the endoscope 1 is used, the first notification mechanism 40 notifies users of device information indicating that the endoscope 1 is, for example, a device suitable for use for infectious patients. In this manner, the first notification mechanism 40 is capable of letting users directly identify a device applicable to infectious patients. Accordingly, the first notification mechanism 40 is capable of preventing users from incorrect use of the endoscope 1.

In addition, the first notification mechanism 40 according to the present embodiment can reduce the labor involved in checking a management device, not illustrated, that manages device information or checking a monitor which displays device information concerning a surgical instrument, upon each time of use. The labor involved in such operation can therefore be suppressed.

Usually, medical devices suitable for use for infectious patients are disposed of after use.

According to the present embodiment, the first notification mechanism 40 notifies users that a medical device itself is usable for infectious patients. As a result, the present embodiment is capable of preventing medical devices from being reused for infectious patients or ordinary patients after having once been used, and infection is thereby prevented from spreading from the infection source.

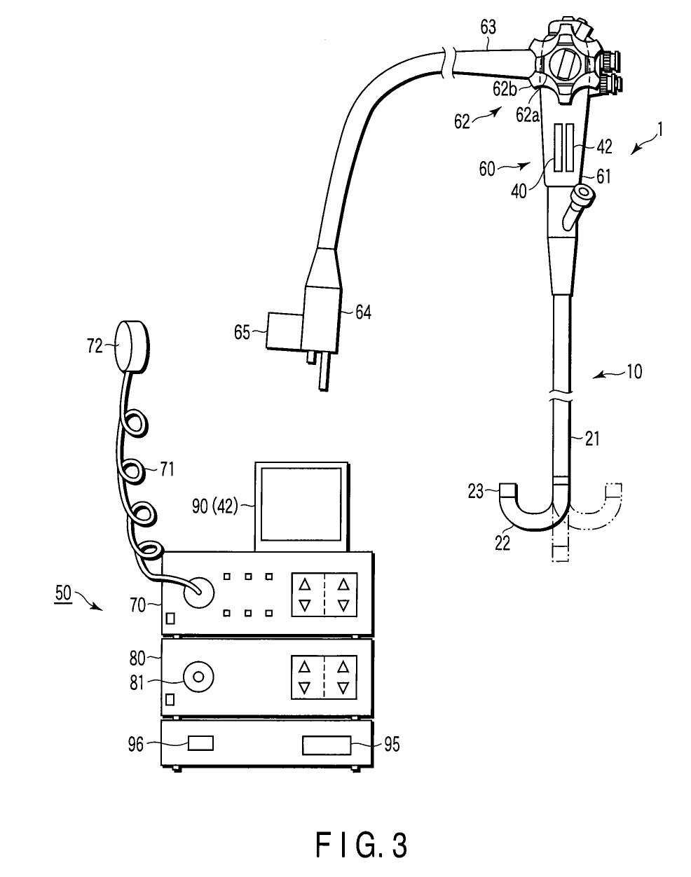

Next, the second embodiment according to the present invention will be described in detail with reference to FIGS. 3 to 5. The present embodiment will be described referring to a medical system including an endoscope which is substantially the same as that in the first embodiment. The same members as those described in the first embodiment will be denoted with the same reference symbols, and detailed descriptions thereof will be omitted herefrom.

In an endoscope 1 according to the present embodiment, as illustrated in FIG. 3, an electric connector section 65, which is detachably connected to a connector 72 at an end of a signal cable 71 connected to a video processor 70, is provided on a side part of a connector section 64. As illustrated in FIG. 3, the endoscope 1 is detachably connected to the video processor 70 through the connector section 64 and the electric connector section 65, and is further detachably connected to a light source device 80 through a connection section 81 described later.

When connected to the endoscope 1 through the signal cable 71, the video processor 70 controls an un-illustrated imaging mechanism of the endoscope 1 and processes signals obtained from the imaging mechanism.

When connected to the endoscope 1 through the connector section 64, the light source device 80 supplies illumination light for an un-illustrated light guide. The video processor 70 and light source device 80 as described above constitute a body section 50 connected to an insertion section 10 as a functional section. The video processor 70 is also connected to a monitor 90. The monitor 90 displays an image corresponding to an imaged subject which is output from the video processor 70.

Further, the body section 50 is provided with the connection section 81 in the light source device 80, which is connected with the endoscope 1 through the connector section 64, an input mechanism 95 that inputs patient information associated with disease information wherein the patient information concerns an infectious patient to be subjected to a medical practice and the disease information concerns a disease of the infectious patient and a second notification mechanism 42 that notifies the patient information or disease information input by the input mechanism 95 when the medical practice is performed on the infectious patient.

The body section 50 has a recording section 96 that records the patient information and disease information input by the input mechanism 95.

The patient information includes, for example, a name, an age, birth year/month/date, and/or a chart of past diagnoses. The disease information indicates, for example, that a patient contracted an infectious disease (such as hepatitis).

The input mechanism 95 may be input with medical schedule information. At this time, the second notification mechanism 42 may notifies the medical schedule information. The medical schedule information includes a schedule of performing a medical practice (treatment), including a date of surgical operation, an expected duration of surgical operation, and/or medical device information indicating a medical device used for a surgical operation, and/or a name of a user (operating surgeon). The medical schedule information is recorded on the recording section 96. The medical device information indicates that a medical device used for a surgical operation is, for example, the endoscope 1. The medical schedule information also includes device list information which lists the endoscope 1 used for a surgical operation. The recording section 96 described above records the device list information listing items of medical device information.

When the endoscope 1 is connected to the video processor 70 or the light source device 80, the second notification mechanism 42 causes the body section 50 to display patient information or disease information on the monitor 90, and medical schedule information may further be displayed as well. Thus, the monitor 90 is a second notification mechanism provided on the body section 50.

Alternatively, the second notification mechanism 42 may be provided on the endoscope 1, as illustrated in FIG. 3. In this case, the second notification mechanism 42 may simply be provided on the endoscope 1 in the same manner as the first notification mechanism 40. Therefore, the second notification mechanism 42 may be provided on at least one of the grip section 61 and the insertion section 10.

When the endoscope 1 is connected (attached) to the video processor 70 or the light source device 80, the body section 50 then determines whether the endoscope 1 is to be used in a surgical operation or not, from device list information. That is, the body section 50 determines whether the medical device information (concerning the endoscope 1 as a medical device used in the surgical operation in this case) is included in device list information or not. If the body section 50 determines that the endoscope 1 is not included in the device list information, the second notification mechanism 42 announces a warning. If the body section 50 determines that the endoscope 1 is included in the device list information, the second notification mechanism 42 announces patient information or disease information and may further announce that the endoscope 1 is not included in the device list information or may further announce medical schedule information.

Thus, the medical system according to the present embodiment includes the endoscope 1 as a medical device, and the body section 50.

Next, an operation method of the medical system according to the present embodiment will be described.

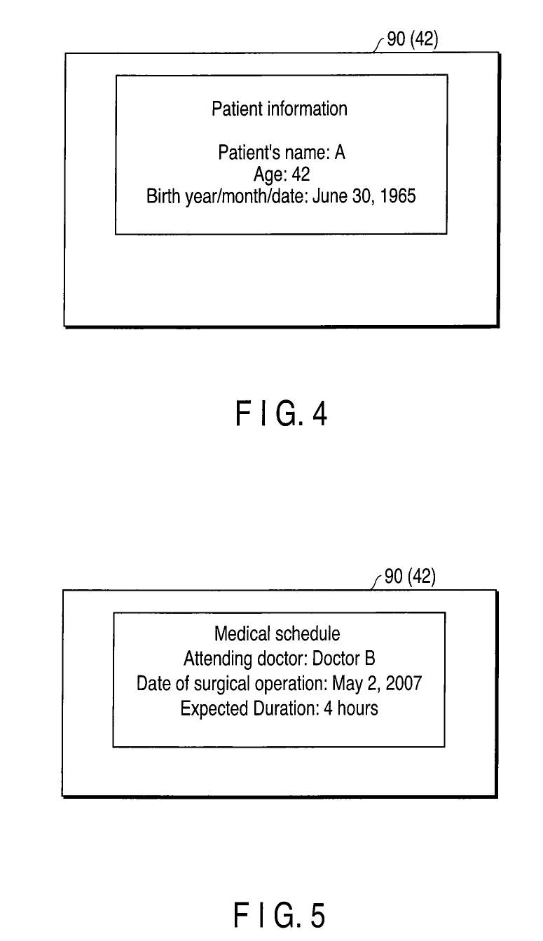

When the endoscope 1 is used by a user, the connector section 64 is connected to the connection section 81, and the electric connector section 65 is connected to the connector 72. As a result, the endoscope 1 is connected to the video processor 70 and the light source device 80 which constitute the body section 50. When the input mechanism 95 inputs patient information together with disease information associated with the patient information, the monitor 90 then announces patient information or disease information. For example, the monitor 90 announces patient information as illustrated in FIG. 4. Alternatively, the second notification mechanism 42 provided on the endoscope 1 may announce the patient information or disease information. The second notification mechanism 42 and/or the monitor 90 may further announce medical schedule information as illustrated in FIG. 5 (from which patient information and disease information are omitted). The second notification mechanism 42 may announce the patient information either at the same time or after the first notification mechanism 40 announces the patient information.

The first notification mechanism 40 operates in the same manner as in the first embodiment, and a detailed description thereof will be therefore omitted herefrom.

Thus, the present embodiment achieves the same effects as the first embodiment.

In addition, according to the present embodiment, patient information or disease information is announced to users by the second notification mechanism 42, and medical schedule information may further be announced as well. In this manner, the present embodiment is capable of more specifically notifying users of applicability of a medical device to infectious patients. Since the second notification mechanism 42 may be provided on the endoscope 1, users can be more directly notified of patient information or disease information, as well as medical schedule information.

When a user performs a medical practice on a patient who contracts an infectious disease, the user can be made aware of the need to pay the closest attention to prevention of infection, according to the present embodiment, which contributes to prevention of infection to users.

What is claimed is:

1. A medical device comprising
a first notification mechanism capable of notifying a user of information indicating that the medical device is suitable for use with a patient having a specified disease.

2. A medical system comprising:
a medical device including a first notification mechanism capable of notifying a user of information indicating that the medical device is suitable for use with a patient having a specified disease;
an input mechanism capable of inputting patient information associated with disease information concerning the disease, the patient information concerning the patient on whom a medical practice is performed;
a second notification mechanism capable of notifying the patient information or the disease information when the medical practice is performed on the patient; and
a body section connected detachably to the medical device and including the input mechanism and the second notification mechanism.

3. The medical system according to claim 2, wherein the second notification mechanism further notifies the medical schedule information.

4. The medical system according to claim 2, wherein the second notification mechanism is provided on the medical device.

5. A medical system comprising:
a medical device having information indicating that the medical device is suitable for use with a patient having a specified disease;
a recording section that records device list information that lists items of medical device information which indicates that a medical device used for a surgical operation;
a body section that is connected detachably to the medical device; and
a notification mechanism by which a warning is notified if the medical device information is determined to be not included in the device list information when the medical device is attached to the body section.
